(19) United States
(12) Patent Application Publication
(10) Pub. No.: US 2009/0072554 A1
(43) Pub. Date: Mar. 19, 2009

(54) PIN-STYLE CARGO SEAL WITH REMOVABLE TRACKING MODULE

(75) Inventor: PAUL R. ARGUIN, Andover, MA (US)

Correspondence Address: MCCORMICK, PAULDING & HUBER LLP, CITY PLACE II, 185 ASYLUM STREET, HARTFORD, CT, 06103, US

(73) Assignee: UNITED SECURITY APPLICATIONS ID. INC., E. WINDSOR, NJ (US)

(21) Appl. No.: 12/208,790

(22) Filed: Sep. 11, 2008

Related U.S. Application Data
(60) Provisional application No. 60/993,599, filed on Sep. 13, 2007.

(51) Int. Cl. E05B 39/02; G09F 3/03; F16B 39/00

(52) U.S. Cl. 292/327

(57) ABSTRACT

A pin-style cargo seal that includes a pin and a tracking module. The tracking module is removably securable to the pin and allows the seal to be tracked while the seal is in transit. The tracking module may be removed from the pin so that the tracking module may be reused.

### CROSS-REFERENCE TO RELATED APPLICATION

This application claims priority from U.S. Provisional Application No. 60/993,599, filed Sep. 13, 2007, titled “PIN-STYLE ‘HIGH SECURITY’ CARGO SEAL WITH REMOVABLE REUSABLE TRACKING INFORMATION MODULE,” which is hereby incorporated by reference in its entirety.

### FIELD OF INVENTION

The present invention relates generally to seals associated with the movement of cargo and more specifically to a pin-style high-security cargo seal having a removable and reusable tracking module.

### BACKGROUND OF THE INVENTION

There are several types of seals used to secure cargo while it is in transit. Such seals are used to demonstrate to the owner of the cargo that the container or other shipping enclosure has not been tampered with. Examples of such seals include cable seals, barrier seals, padlock seals and bolt or pin-style seals. Typically, pin-style seals are used in high-security applications and employ a pin or bolt. Common practice in the industry is to cut the pin-style cargo seal off with bolt cutters in order to access the contents of, for example, a container.

As will be appreciated, it is also desirable to track a seal while it is in transit. Radio frequency identification (“RFID”) provides a means of electronically tracking a seal. Likewise, global positioning systems (“GPS”), GSM or GPRS may be employed to determine a location of a seal equipped with a GPS receiver. Given the desirability of tracking during transit, certain known seals come equipped with tracking electronics. Such seals, however, are reusable, i.e., the entire seal can be reused, and are therefore quite expensive.

With the forgoing in mind, it is the general object of the present invention to provide a pin style cargo seal that includes a separate, removable module containing electronics that allow the seal to be tracked while in transit.

### SUMMARY OF THE INVENTION

It is an object of the present invention to provide a pin-style cargo seal.

It is an additional object of the present invention to provide a high-security pin-style cargo seal with a removable tracking module.

It is another object of the present invention to provide a high-security pin-style cargo seal having a removable and reusable tracking module.

It is yet another object of the present invention to provide a high-security pin-style cargo seal with tracking capabilities having a reduced cost and ease of manufacture through the use of a removable and reusable tracking module.

It is an additional object of the present invention to provide a high-security pin-style cargo seal having a single-use seal portion and a removable and reusable tracking module.

An embodiment of the present invention is a pin-style cargo seal that includes a pin and a tracking module. The tracking module is removably securable to the pin and allows the seal to be tracked while the seal is in transit. The tracking module may be removed from the pin so that the tracking module may be reused.

These and other objects of the present invention, and their preferred embodiments, shall become clear by consideration of the specification, claims and drawings taken as a whole.

### BRIEF DESCRIPTION OF THE DRAWINGS

FIG. 1 illustrates a pin-style cargo seal having a removable and reusable tracking module according to one embodiment of the present invention.

FIG. 2 schematically depicts internal components of the tracking module of FIG. 1.

FIG. 3 graphically illustrates a system utilizing the pin-style cargo seal and tracking module of FIG. 1.

### DETAILED DESCRIPTION OF THE PREFERRED EMBODIMENT

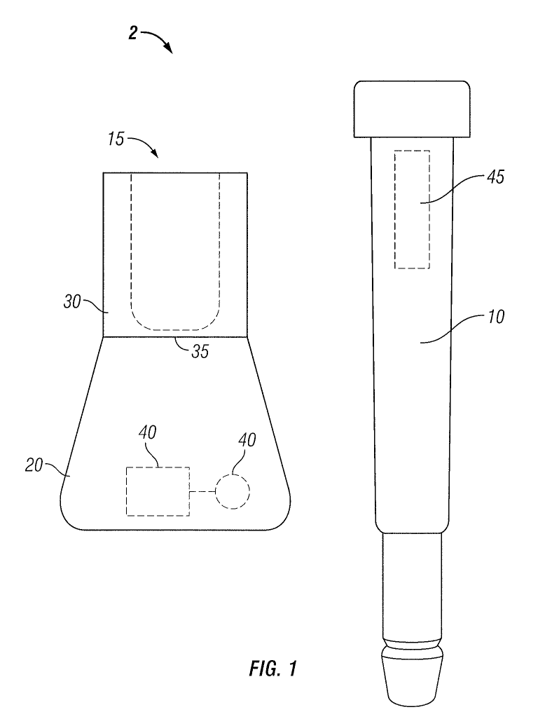

Referring to FIG. 1, the inventive pin-style cargo seal 2 includes a pin 10 and a removable and reusable tracking module 20. The pin portion is preferably a single-use pin, which may be selectively attached to the reusable tracking module 20. The seal 2 also includes a barrel portion 30 with an internal locking mechanism (not shown). The barrel portion 30 and tracking module 20 are depicted as abutting and attached at line 35. While FIG. 1 depicts the barrel portion 30 removably secured to the tracking module 20, other configurations are possible as long as the tracking module 20 can be removed from the seal 2 for reuse. For example, the tracking module 20 could be removably secured to the pin 10 at a pin end opposite the barrel portion 30. Likewise, the shape and dimensions of the tracking portion 20 may be varied to accommodate electronics of various sizes and shapes.

In use, the tracking module 20 is secured to the barrel portion 30. The pin 10 is then inserted into an opening 15 in the barrel portion 30 and is fixedly attached thereto. The pin 10 must be cut with bolt cutters or the like to remove the barrel portion 30. Thus, the pin 10 and barrel portion 30 are not reusable. The tracking module 20 may be removed from the barrel portion 30, either before or after the bolt has been cut for reuse.

The removable and reusable tracking module 20 is an important aspect of the inventive cargo seal 2. The module 20 may be removed from a single use pin and barrel and then reused. This facilitates the manufacture of relatively inexpensive pin and barrel that does not include electronics. Such cargo seals 2 and tracking modules 20 are previously unknown in the art.

In addition to the inventive removable and reusable tracking module 20, the pin 10 and barrel 30 itself may optionally have an RFID component 45. This optional RFID component 45 could deactivate upon cutting the seal i.e., cutting the bolt, or through tampering.

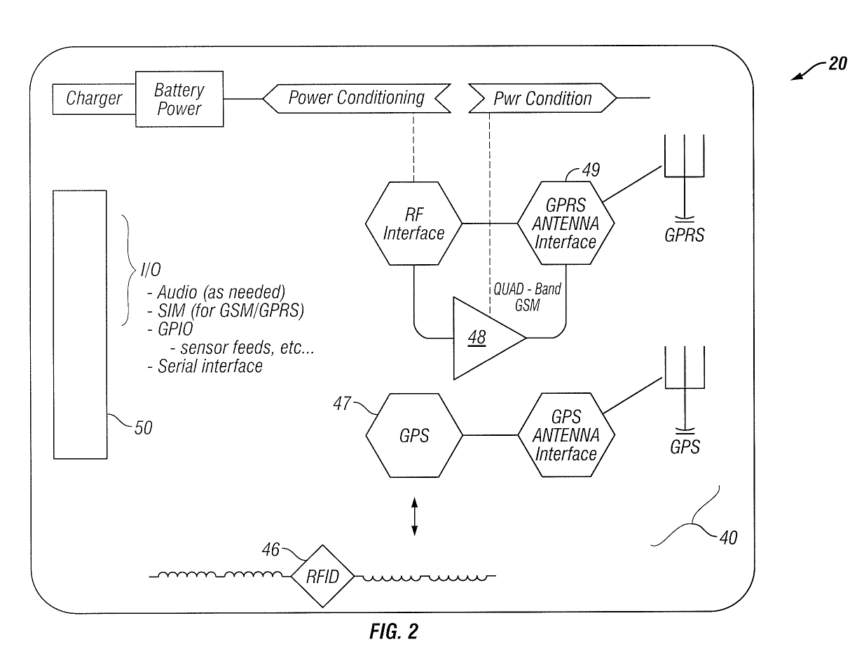

Referring now to FIG. 2, the preferred electronics in the tracking module 20 of the inventive cargo seal include RFID 46. The RFID 46 may be either active, passive, semi-active, or semi-passive. The electronics also include GPS 47 and cellular technology. The cellular technology is typically Global System for Mobile Communications 48, (“GSM”), due to the extensive coverage, but can be also be Code Division Multiple Access, (“CDMA”), or other technologies, and General Packet Radio Service 49, (“GPRS”).

The preferred cellular technology is GSM which is the dominant technology used around the globe and is available in more than 100 countries for mobile/cellular communication. It is the standard for communication for most of Asia and Europe. GSM allows for simultaneous calls on the same radio frequency and uses “narrowband” TDMA, the technology that enables digital transmissions between a mobile phone and a base station. With TDMA the frequency band is divided into multiple channels which are then stacked together into a single stream, hence the term narrowband. This technology allows several callers to share the same channel at the same time.

In addition, GPRS is a mobile data service available to users of GSM. GPRS can be used for services such as Wireless Application Protocol (WAP) access, Short Message Service (SMS), Multimedia Messaging Service (MMS), and for Internet communication services such as email and World Wide Web. While the preferred cellular technology is GSM and GPRS due to coverage, as will be appreciated, other technologies may be used.

In particular, the inventive module preferably includes an input/output (“I/O”) means 50. The I/O means 50 allows for the addition of various sensors to be connected. Data from these sensors can be transmitted via the GSM/ GPRS network in the same manner as the GPS data.

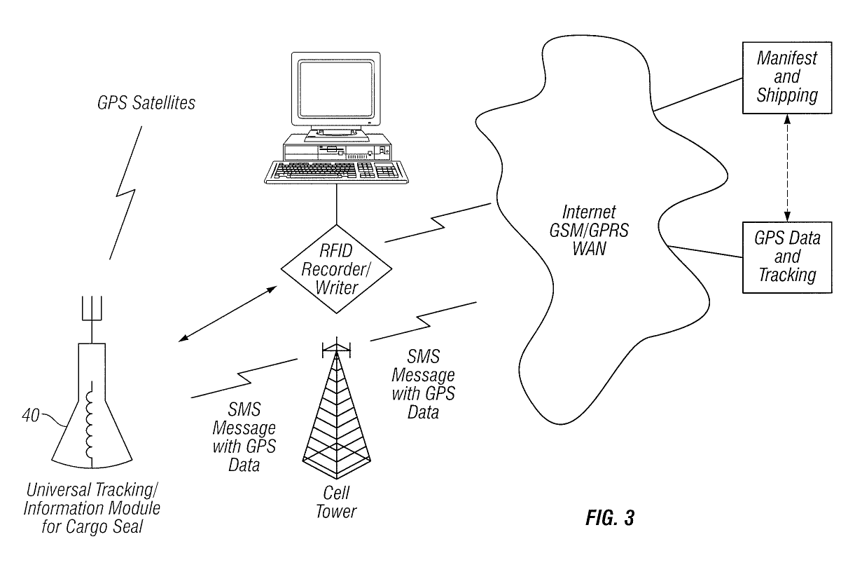

Turning now to FIG. 3, it is another object of the present invention to provide a universal tracking module 40 that includes a software system linked with the scanning of the RFID which provides all shipping and manifest information of the container, truck, train, or the like. A scan of the RFID automatically verifies that the seal is valid, and provides alerts if the seal has been tampered with. If the scan proves to be of a valid seal module, the shipping data is displayed from the centralized data repository. Further, if the need exists, data from US Customs AMS for Overseas Ocean and Air Shipments and associated systems for tucking and train can be accessed via this portal. The scan is linked to the central data repository via the Internet.

The present invention also provides a universal tracking system that is capable of providing authorized users access to the exact location of a cargo shipment using the onboard GPS. The onboard GPS receives its location which gets transmitted via GSM and GPRS. This would typically be transmitted via the Short Message Service (SMS), but can be transmitted via any available technology. Once transmitted, an individual phone, PDA, computer or web-based service can display the location of the shipment. The transmissions of locations are saved to allow for the automated plotting of the route a shipment has taken.

The GPS tracker in the module will allow authorized users to query the location on demand, to set the frequency of reporting, to review historical information, to view health of the module, and any of the GPS data that has been recorded.

Preferably, a Web based interface is provided for the RFID and shipping data. All shipment and manifest information is available for review upon user authentication. A Web based interface is also available for the GPS and shipping data. A standard mapping program can be used to display the overlay containing the tracking information of the given shipment. Further, the shipment information is provided upon a single click of the track of the map based track “blip”.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

I claim:

1. A pin-style cargo seal, said pin-style cargo seal comprising:
a pin;
a tracking module removably securable to said pin, said tracking module allowing said seal to be tracked while said seal is in transit; and
wherein said tracking module may be removed from said pin so that said tracking module may be reused.

2. The pin-style cargo seal of claim 1, further comprising:
a barrel portion that may be fixed to said pin to secure said seal while in use.

3. The pin-style cargo seal of claim 2, wherein said pin must be cut to open said seal after said pin has been fixed to said barrel portion.

4. The pin-style cargo seal of claim 1, wherein said tracking module includes and utilizes RFID to track said seal.

5. The pin-style cargo seal of claim 1, wherein said tracking module includes and utilizes GPS to determine a specific location of said seal.

6 The pin-style cargo seal of claim 5, wherein said tracking module includes a cellular mechanism to transmit data from said global positioning system.

7. The pin-style cargo seal of claim 6, wherein said cellular mechanism utilizes GSM.

8. The pin-style cargo seal of claim 6, wherein said cellular mechanism utilizes CDMA.

9. The pin-style cargo seal of claim 7, wherein said tracking module utilizes GPRS to transmit data.

10. The pin-style cargo seal of claim 1, wherein said tracking module includes an input/output mechanism.
